(19) United States
(12) Patent Application Publication
(10) Pub. No.: US 2025/0185682 A1
(43) Pub. Date: Jun. 12, 2025

(54) OIL AND FAT COMPOSITION, METHOD OF PRODUCING OIL AND FAT COMPOSITION, FLAVOR ENHANCER, AND FOOD

(71) Applicants: KEWPIE CORPORATION, Tokyo (JP); Kewpie Jyozo Co., Ltd., Tokyo (JP)

(72) Inventors: Riho IWAMI, Tokyo (JP); Takuya YANAGISAWA, Tokyo (JP); Yusuke OKUDA, Tokyo (JP); Hideaki KOBAYASHI, Tokyo (JP); Akifumi MIKAMI, Tokyo (JP)

(73) Assignees: KEWPIE CORPORATION, Tokyo (JP); Kewpie Jyozo Co., Ltd., Tokyo (JP)

(21) Appl. No.: 18/838,865

(22) PCT Filed: Mar. 30, 2023
(86) PCT No.: PCT/JP2023/013387

§ 371 Date: Aug. 15, 2024

(30) Foreign Application Priority Data
Mar. 30, 2022 (JP) 2022-057404

(51) Int. Cl. A23D 9/007; A23D 9/04

(52) U.S. Cl. CPC A23D 9/007; A23D 9/04

(57) ABSTRACT

Provided is an oil and fat composition that can enhance the flavor of food without adversely affecting the flavor of the food by adding the composition to the food. The oil and fat composition of the present invention includes: an edible vegetable oil and fat extract of an acetic acid bacterium; and insoluble matter that is not passed through a mesh of 1 μm and is derived from the bacterial cells of an acetic acid bacterium, the insoluble matter being 1% by mass or less.

### BACKGROUND OF THE INVENTION

### Technical Field

The present invention relates to an oil and fat composition and a method of producing an oil and fat composition. The present invention particularly relates to an oil and fat composition containing an edible vegetable oil and fat extract of an acetic acid bacterium, and a method of producing the oil and fat composition. The present invention also relates to a flavor enhancer containing the oil and fat composition. Further, the present invention also relates to a food containing the oil and fat composition.

### Background Art

Conventionally, the bacterial cells of microorganisms have had various physiological functions, and have been therefore utilized in various foods. For example, lactic acid bacteria are included in fermented foods such as yogurt and cheese, and such lactic acid bacteria have been known to be helpful in improving and promoting health, for example, improving enteral environment.

Acetic acid bacteria have been well known to be used in production of vinegar. However, the bacterial cells of such acetic acid bacteria have peculiar smells, and have been able to adversely affect food flavors. Therefore, foods using the bacterial cells of acetic acid bacteria per se have been less than foods using lactic acid bacteria, and have been able to be considered to be insufficiently utilized. In recent years, however, utilization of acetic acid bacteria in food has been examined. For example, Patent Literature 1 proposes, as a flavor adjuster for food, a composition containing an acetic acid bacterium, in which the smell of the bacterial cells of an acetic acid bacterium is suppressed by adjusting the peak area ratio of certain flavor components (nonanal, methylheptenone, dimethyl trisulphide, and 2-tridecanone) in the case of measuring the peak area ratio by stir bar sorptive extraction-thermal desorption-gas chromatography mass spectroscopy.

### CITATION LIST

### Patent Literature

[Patent Literature 1] Japanese Patent No. 6755606

### SUMMARY OF THE INVENTION

### Technical Problem

However, such a composition containing the bacterial cells of an acetic acid bacterium as described in Patent Literature 1 has still been susceptible to improvement in flavor. Accordingly, an objective of the present invention is to provide an oil and fat composition that can enhance the flavor of food without adversely affecting the flavor of the food by adding the composition to the food.

### Solution to Problem

As a result of sincere examination of such problems described above, the present inventors found that the above-described problems can be solved by allowing an oil and fat composition to contain an edible vegetable oil and fat extract of an acetic acid bacterium, and removing the acetic acid bacterium per se. The present inventors accomplished the present invention on the basis of such findings.

In other words, in accordance with a first aspect of the present invention,
there is provided an oil and fat composition that includes an edible vegetable oil and fat extract of an acetic acid bacterium and insoluble matter that is not passed through a mesh of 1 μm and is derived from a bacterial cell of an acetic acid bacterium, the insoluble matter being 1% by mass or less.

In the first aspect of the present invention, the acetic acid bacterium is an acetic acid bacterium of at least one selected from a group consisting of genera Gluconacetobacter, Acetobacter, and Komagataeibacter.

In the first aspect of the present invention, it is preferable that the oil and fat composition further includes an edible vegetable oil and fat.

In the first aspect of the present invention, it is preferable that the oil and fat composition is for use in food.

In accordance with a second aspect of the present invention, there is provided a food flavor enhancer including the oil and fat composition.

In accordance with a third aspect of the present invention, there is provided a food including the oil and fat composition.

In accordance with a fourth aspect of the present invention, there is provided a method of producing an oil and fat composition including an edible vegetable oil and fat extract of an acetic acid bacterium, the method including:
a step of heating a liquid containing an acetic acid bacterium; and
a step of mixing the heated liquid containing the acetic acid bacterium with an edible vegetable oil and fat to extract an oil-soluble component derived from a bacterial cell of the acetic acid bacterium in the edible vegetable oil and fat.

In accordance with a fifth aspect of the present invention, there is provided a method of producing an oil and fat composition including an edible vegetable oil and fat extract of an acetic acid bacterium, the method including:
a step of mixing a liquid containing an acetic acid bacterium or dry matter of a bacterial cell of an acetic acid bacterium with an edible vegetable oil and fat to obtain a liquid mixture; and
a step of heating the liquid mixture to extract an oil-soluble component derived from the bacterial cell of the acetic acid bacterium in the edible vegetable oil and fat.

In the fourth or fifth aspect of the present invention, it is preferable that heating temperature is 40° C. or more and 130° C. or less.

In the fourth or fifth aspect of the present invention, it is preferable that a pH of the liquid containing the acetic acid bacterium is 2.0 or more and 7.0 or less.

In the fourth or fifth aspect of the present invention, it is preferable that an amount of the dry matter of the bacterial cell of the acetic acid bacterium is 1 part by mass or more and 100 parts by mass or less with respect to 100 parts by mass of the edible vegetable oil and fat.

### Advantageous Effects of Invention

In accordance with the present invention, there can be provided an oil and fat composition that can enhance the flavor of food without adversely affecting the flavor of the food by adding the composition to the food.

### DETAILED DESCRIPTION OF THE INVENTION

### <Oil And Fat Composition>

An oil and fat composition of the present invention includes an edible vegetable oil and fat extract of an acetic acid bacterium and insoluble matter that is not passed through a mesh of 1 μm and is derived from the bacterial cell of an acetic acid bacterium, the insoluble matter being 1% by mass or less. The content of the insoluble matter that is not passed through a mesh of 1 μm and is derived from the bacterial cell of the acetic acid bacterium is preferably 0.5% mass or less, more preferably 0.1% by mass or less, with respect to the total amount of the oil and fat composition. It is still more preferable that the oil and fat composition of the present invention includes does not include the insoluble matter that is not passed through a mesh of 1 μm and is derived from the bacterial cell of the acetic acid bacterium. Moreover, the oil and fat composition of the present invention is preferably for use in food. In particular, the flavor of food can be enhanced without adversely affecting the flavor of the food by adding, to the food, the oil and fat composition in which the content of the insoluble matter that is not passed through a mesh of 1 μm and is derived from the bacterial cell of the acetic acid bacterium is small. Here, the phrase “not passed through a mesh of 1 μm” means that passing is not achieved in the case of filtration using a filter having an opening of 1 μm. The content of the insoluble matter that is not passed through a mesh of 1 μm and is derived from the bacterial cell of the acetic acid bacterium can be measured by a method described in detail in <Method of Measuring Content of Insoluble Matter That Is Not Passed through Mesh of 1 μm And Is Derived from Bacterial Cell of Acetic Acid Bacterium> in Examples as described below.

### (Acetic Acid Bacterium)

The acetic acid bacterium is not particularly limited, and a conventionally known acetic acid bacterium can be used. Specific examples of the acetic acid bacterium include acetic acid bacteria of the genera Gluconacetobacter, Acetobacter, Komagataeibacter, and Gluconobacter. Of these, it is preferable to use an acetic acid bacterium of at least one selected from the group consisting of the genera Gluconacetobacter, Acetobacter, and Komagataeibacter.

Examples of acetic acid bacteria of the genus Gluconacetobacter include Gluconacetobacter swingsii, Gluconacetobacter xylinus, Gluconacetobacter diazotrophicus, Gluconacetobacter intermedius, Gluconacetobacter sacchari, Gluconacetobacter maltaceti, Gluconacetobacter kombuchae, and Gluconacetobacter liquefaciens.

Examples of acetic acid bacteria of the genus Acetobacter include Acetobacter polyoxogenes, Acetobacter tropicalis, Acetobacter indonesiensis, Acetobacter syzygii, Acetobacter cibinongensis, Acetobacter orientalis, Acetobacter pasteurianus, Acetobacter orleanensis, Acetobacter lovaniensis, Acetobacter aceti, Acetobacter pomorum, and Acetobacter malorum.

Examples of acetic acid bacteria of the genus Komagataeibacter include Komagataeibacter hansenli, Komagataeibacter xylinus, Komagataeibacter europaeus, and Komagataeibacter oboediens.

Examples of acetic acid bacteria of the genus Gluconobacter include Gluconobacter frateurii and Gluconobacter cerinus.

### (Edible Vegetable Oil and Fat)

The edible vegetable oil and fat that is used for extraction is not particularly limited, and a conventionally known edible vegetable oil and fat can be used. Specifically, for example, rape oil, soybean oil, white sesame oil, corn oil, palm oil, cottonseed oil, sunflower oil, safflower oil, olive oil, linseed oil, rice oil, camellia oil, perilla oil, grape seed oil, peanut oil, almond oil, avocado oil, MCT (oil and fat containing medium-chain triglyceride), or the like can be used as the edible vegetable oil and fat. Of these, it is preferable to use at least one selected from rape oil, soybean oil, white sesame oil, and rice oil.

The edible vegetable oil and fat that is used for extraction has a lower polarity than that of a common extracting solvent (water, methanol, ethyl acetate, chloroform, or the like), and particularly has a relative permittivity value of preferably 4.0 or less, more preferably 3.8 or less, and still more preferably 3.5 or less, and preferably 2.5 or more, more preferably 2.7 or more, and still more preferably 2.9 or more. For example, the relative permittivity of rape oil is 3.0, the relative permittivity of soybean oil is 2.9 to 3.5, the relative permittivity of cottonseed oil is 3.1, and the relative permittivity of linseed oil is 3.2 to 3.5. Use of an edible vegetable oil and fat having a low polarity low (low relative permittivity) facilitates extraction of an oil-soluble component derived from the desired bacterial cell of an acetic acid bacterium.

The relative permittivity can be measured at 25° C. by a usual method using a dielectric constant meter (dielectric constant meter for liquid, Model 871, manufactured by MITSUWA FRONTECH CORP., or the like).

### (Edible Vegetable Oil and Fat Extract of Acetic Acid Bacterium)

The edible vegetable oil and fat extract of an acetic acid bacterium refers to each of various active components released outside bacterial cells by heating the acetic acid bacterium, the active components being able to be extracted with the edible vegetable oil and fat (oil-soluble components derived from bacterial cells of acetic acid bacteria). A specific component of the edible vegetable oil and fat extract of the acetic acid bacterium is not particularly limited, and examples thereof include oil-soluble flavor components, fatty acids, and oil-soluble component such as sterols. However, the edible vegetable oil and fat extract may include neither a ceramide derived from an acetic acid bacterium nor an alkaline-stable lipid derived from an acetic acid bacterium.

### (Other Raw Material)

The oil and fat composition of the present invention may include an edible vegetable oil and fat used for extraction, or may include another raw material as long as the effects of the present invention are not impaired, as well as the above-described edible vegetable oil and fat extract of an acetic acid bacterium. As such other raw materials, various raw materials that are usually used for food applications may be selected as appropriate, and blended. Examples of the other raw materials include water, acid materials, pH adjusters, salts, thickeners, coloring agents, flavoring agents, and preservatives.

### (Method of Producing Oil and Fat Composition)

A method of producing an oil and fat composition of the present invention includes (1) a step of heating a liquid containing an acetic acid bacterium, and a step of mixing the heated liquid containing the acetic acid bacterium with an edible vegetable oil and fat to extract an oil-soluble component derived from a bacterial cell of the acetic acid bacterium in the edible vegetable oil and fat. An active component derived from the acetic acid bacterium is released outside the bacterial cell by heating the liquid containing the acetic acid bacterium, and the oil-soluble component derived from the bacterial cell of the acetic acid bacterium can be extracted in the edible vegetable oil and fat by then mixing the component with the edible vegetable oil and fat.

Alternatively, a method of producing an oil and fat composition of the present invention includes (2) a step of mixing a liquid containing an acetic acid bacterium or dry matter of a bacterial cell of an acetic acid bacterium with an edible vegetable oil and fat to obtain a liquid mixture, and a step of heating the liquid mixture to extract an oil-soluble component derived from the bacterial cell of the acetic acid bacterium in the edible vegetable oil and fat. The heating of the liquid mixture of the liquid containing the acetic acid bacterium or the dry matter of the bacterial cell of the acetic acid bacterium with the edible vegetable oil and fat enables release of an active component derived from the acetic acid bacterium outside the bacterial cell and the extraction of the oil-soluble component derived from the bacterial cell of the acetic acid bacterium in the edible vegetable oil and fat to be simultaneously performed.

The dry matter of the acetic acid bacterium can be obtained by drying the liquid containing the acetic acid bacterium by a usual method.

As described above, in the method of producing an oil and fat composition of the present invention, the heating of the acetic acid bacterium may be performed in the state of the liquid containing the acetic acid bacterium (in the state of the liquid before the liquid is mixed with the edible vegetable oil and fat), or may be performed after the liquid containing the acetic acid bacterium or the dry matter of the bacterial cell of the acetic acid bacterium is mixed with the edible vegetable oil and fat. The above-described heating and extraction can be performed by a usual method using a conventionally known apparatus.

The liquid containing the acetic acid bacterium is a liquid in which the bacterial cell of the acetic acid bacterium is included in water, and may be, for example, a dispersion liquid or suspension of the bacterial cell of an acetic acid bacterium. The amount of the dry matter of the bacterial cell of the acetic acid bacterium in the liquid containing the acetic acid bacterium is not particularly limited, but is preferably 1% by mass or more and 20% by mass or less, more preferably 2% by mass or more and 15%/0 by mass or less, and still more preferably 3% by mass or more and 12% by mass or less from the viewpoint of extraction efficiency.

A temperature at which the liquid containing the acetic acid bacterium is heated or a temperature at which the liquid mixture of the acetic acid bacterium and the edible vegetable oil and fat is heated is preferably 40° C. or more and 130° C. or less, more preferably 45° C. or more and 125° C. or less, and still more preferably 50° C. or more and 120° C. or less. When the heating temperature is within the range described above, the amount of the active component released outside the bacterial cell can be increased to improve extraction efficiency.

(1) When the heated liquid containing the acetic acid bacterium and the edible vegetable oil and fat are mixed to extract the oil-soluble component, a temperature at which the oil-soluble component derived from the bacterial cell of the acetic acid bacterium is extracted is not limited, but may be lower than the heating temperature described above, and is preferably 10° C. or more and 50° C. or less, more preferably 15° C. or more and 45° C. or less. (2) When the heating and the extraction are simultaneously performed in the state of the liquid mixture of the acetic acid bacterium and the edible vegetable oil and fat, the extraction temperature is similar to the heating temperature described above.

Time for which the liquid containing the acetic acid bacterium is heated or time for which the liquid mixture of the acetic acid bacterium and the edible vegetable oil and fat is heated is not particularly limited in a state in which the active component can be extracted from the bacterial cell of the acetic acid bacterium, but is preferably 1 minute or more, more preferably 5 minutes or more, and still more preferably 10 minutes or more.

The pH of the liquid containing the acetic acid bacterium is preferably 2.0 or more and 7.0 or less, more preferably 3.0 or more and 6.5 or less, and still more preferably 4.0 or more and 6.0 or less from the viewpoint of extraction efficiency. The pH of the liquid containing the acetic acid bacterium can be adjusted using a pH adjuster such as an aqueous sodium hydroxide solution or hydrochloric acid, and the like.

When the oil-soluble component derived from the bacterial cell of the acetic acid bacterium is extracted with the edible vegetable oil and fat, the amount of the dry matter of the bacterial cell of the acetic acid bacterium is preferably adjusted to 1 part by mass or more and 100 parts by mass or less, more preferably adjusted to 5 parts by mass or more and 70 parts by mass or less, and still more preferably adjusted to 10 parts by mass or more and 50 parts by mass or less, with respect to 100 parts by mass of the edible vegetable oil and fat, from the viewpoint of extraction efficiency.

The oil-soluble component derived from the bacterial cell of the acetic acid bacterium is extracted in the edible vegetable oil and fat by the above-described method (1) or (2), and a step of removing the bacterial cell of the acetic acid bacterium by centrifugation, decantation, filtration, or the like is then carried out. Subsequently, an oil phase and an aqueous phase are separated, and an oil phase portion is collected, whereby the edible vegetable oil and fat extract of the acetic acid bacterium can be obtained.

### (Food)

The food to which the oil and fat composition is added is not particularly limited, but may be a conventionally known food. Examples of the food may include: egg-processed foods such as egg spreads, Japanese omelets, omelets, bowls of rice topped with chickens and eggs, and puddings; seasonings such as mayonnaises, dressings, soy sauces, sauces, and basting; soups such as Japanese stock soups, consomme soups, and Chinese soups; and creams.

A method of adding the oil and fat composition to the food is not particularly limited, but the addition can be performed by a conventionally known method. For example, the oil and fat composition of the present invention may be added in the step of producing the food, or may be added after the production of the food.

The amount of the food added to the oil and fat composition can be adjusted as appropriate depending on the concentration of the edible vegetable oil and fat extract of the acetic acid bacterium in the oil and fat composition. For example, the amount of the oil and fat composition added to the food is preferably 0.1 parts by mass or more and 10 parts by mass or less, more preferably 0.2 parts by mass or more and 7 parts by mass or less, and still more preferably 0.5 parts by mass or more and 5 parts by mass or less, with respect to 100 parts by mass of the food. When the amount of the oil and fat composition added to the food is within the range described above, the effect of enhancing the flavor of the food is easily obtained without adversely affecting the flavor of the food.

### <Food Flavor Enhancer and Food>

The food flavor enhancer of the present invention includes the oil and fat composition described above. Moreover, the food of the present invention includes the oil and fat composition described above. The addition of the food flavor enhancer of the present invention to the food enables the flavor of a food to be enhanced without adversely affecting the flavor of the food. The food of which the flavor can be enhanced is not particularly limited, but may be a conventionally known food. Examples of the food are similar to those of the above-described food to which the oil and fat composition is added.

### EXAMPLES

The present invention is described below in more detail with reference to Examples and Comparative Examples. However, the present invention is not construed as limitation to the contents of the following Examples.

### Production Example 1 of Oil and Fat Composition

### Example 1

### <Preparation of Liquid Containing Acetic Acid Bacterium>

To 4 parts by mass of ethanol, 0.2 parts by mass of yeast extract, and 95.7 parts by mass of clear water, 0.1 parts by mass of acetic acid bacteria (mixed bacterial cells of the genera Gluconacetobacter, Acetobacter, and Komagataeibacter) were added, and the resultant was cultured for 24 hours under conditions of a product temperature of 30° C. and an airflow rate of 0.4 L/min per volume of culture liquid. The obtained acetic acid bacterium solution was subjected to centrifugal concentration treatment, and washed several times with clear water, and a liquid containing an acetic acid bacterium (amount of dry matter of bacterial cells of acetic acid bacterium: 5% by mass) was then prepared. As a result of measuring the pH of the liquid containing the acetic acid bacterium by using a pH measurement instrument (desktop type pH meter F-72, manufactured by HORIBA, Ltd.) at I atmospheric pressure and a product temperature of 20° C., the pH was 5.0.

### <Preparation of Oil and Fat Composition>

Three hundred parts by mass (amount of dry matter of bacterial cells of acetic acid bacterium: 15 parts by mass) of the liquid containing the acetic acid bacterium (amount of dry matter of bacterial cells of acetic acid bacterium: 5% by mass), prepared as described above, and 100 parts by mass of an edible vegetable oil and fat (rape oil, relative permittivity of 3.0) were mixed. Then, the mixture was heated to 90° C. while stirring the mixture, and extracted for 10 minutes. Then, the heated mixture was separated into an oil phase and an aqueous phase by centrifugation, the oil phase was collected, and an oil and fat composition containing an edible vegetable oil and fat extract of an acetic acid bacterium was obtained.

<Method of Measuring Content of Insoluble Matter That Was Not Passed through Mesh of 1 μm And Was Derived from Bacterial Cells of Acetic Acid Bacterium>

Subsequently, the content of insoluble matter that was not passed through a mesh of 1 μm and was derived from the bacterial cells of an acetic acid bacterium in the obtained oil and fat composition was measured by the following method. As a result of the measurement, the content of the insoluble matter derived from the bacterial cells of the acetic acid bacterium in the oil and fat composition was 0% by mass.

### (Measurement Conditions)

Pressurization type filtration
Use of membrane filter (PTFE (for oil and fat)/ITEM T100A293D/LOT: 81212430/PORE SIZE 1.0 μm, manufactured by ADVANTEC)
Performance of the following steps I to V:
   I: Measurement of mass of filter before filtration
   II: Mixing of 2 g of oil and fat composition with 20 g of acetone
   II: Pressurization type filtration of mixture
   IV: Drying of mixture (removal of acetone)
   V: Measurement of mass of filter after filtration

“Content of insoluble matter”=“mass of filter after filtration”−“mass of filter before filtration”

### Examples 2 to 5

An oil and fat composition that included an edible vegetable oil and fat extract of an acetic acid bacterium and insoluble matter that was not passed through a mesh of 1 μm and was derived from the bacterial cells of the acetic acid bacterium, the insoluble matter being 0% by mass, was obtained in a manner similar to that in Example 1 except that a temperature at which a mixture was heated was changed to a temperature set forth in Table 1.

### Examples 6 to 8

An oil and fat composition that included an edible vegetable oil and fat extract of an acetic acid bacterium and insoluble matter that was not passed through a mesh of 1 μm and was derived from the bacterial cells of the acetic acid bacterium, the insoluble matter being 0% by mass, was obtained in a manner similar to that in Example 1 except that time for which a mixture was extracted was changed to time set forth in Table 1.

### Example 9

The acetic acid bacterium solution obtained in <Preparation of Liquid Containing Acetic Acid Bacterium> as described above was subjected to centrifugal concentration treatment, and washed several times with clear water, and a liquid containing an acetic acid bacterium (amount of dry matter of bacterial cells of acetic acid bacterium: 10% by mass) was then prepared. Subsequently, an oil and fat composition that included an edible vegetable oil and fat extract of an acetic acid bacterium and insoluble matter that was not passed through a mesh of 1 μm and was derived from the bacterial cells of the acetic acid bacterium, the insoluble matter being 0% by mass, was obtained in a manner similar to that in Example 1 except that 300 parts by mass (amount of dry matter of bacterial cells of acetic acid bacterium: 30 parts by mass) of a liquid containing an acetic acid bacterium (amount of dry matter of bacterial cells of acetic acid bacterium: 10% by mass) and 100 parts by mass of an edible vegetable oil and fat (rape oil) were mixed.

### Comparative Example 1

The liquid containing the acetic acid bacterium (amount of dry matter of bacterial cells of acetic acid bacterium: 5% by mass) per se, prepared as described above, was heated to obtain a composition including an acetic acid bacterium and a water extract of the acetic acid bacterium.

### Comparative Example 2

The liquid containing the acetic acid bacterium (amount of dry matter of bacterial cells of acetic acid bacterium: 5% by mass), prepared as described above, was mixed with an edible vegetable oil and fat (rape oil). Then, the mixture was extracted at a kept ordinary temperature (25° C.) for 15 minutes while stirring the mixture. Then, the mixture was separated into an oil phase and an aqueous phase by centrifugation, an oil phase was collected, and an oil and fat composition was obtained.

### <Sensory Evaluation 1 (Flavor)>

To 100 parts by mass of roasted sesame dressing, 1 part by mass of the oil and fat composition obtained as described above was added, and the resultant was stirred until being homogeneous. Subsequently, the flavor of the sesame dressing was subjected to sensory evaluation according to the following criteria. A sesame dressing to which the oil and fat composition was not added was regarded as a control product. The results of the sensory evaluation are as set forth in Table 1. In the following evaluation criteria, criteria of “2” or more exhibit favorable results.

### [Evaluation Criteria]

4: The flavor of sesame was considerably enhanced in comparison with the control product.
3: The flavor of sesame was enhanced in comparison with the control product.
2: The flavor of sesame was slightly enhanced in comparison with the control product.
1: The flavor of sesame was not enhanced in comparison with a control product.

### <Sensory Evaluation 2 (Flavor)>

The oil and fat composition obtained in Example 1 was added at each rate set forth in Table 2 to 100 parts by mass of each food set forth in Table 2, and the resultant was stirred until being homogeneous. Subsequently, the flavor of each food was subjected to sensory evaluation according to the following criteria. Each food to which the oil and fat composition was not added was regarded as a control product. The results of the sensory evaluation are as set forth in Table 2.

### [Evaluation Criteria](Mayonnaise, Egg Spread, Custard Cream, Carbonara Sauce)

4: The flavor of egg was considerably enhanced in comparison with the control product.
3: The flavor of egg was enhanced in comparison with the control product.
2: The flavor of egg was slightly enhanced in comparison with the control product.
1: The flavor of egg was not enhanced in comparison with a control product.

### [Evaluation Criteria](Soy Sauce)

4: Saltiness, taste, and the flavor of soy sauce were considerably enhanced in comparison with the control product.
3: Saltiness, taste, and the flavor of soy sauce were enhanced in comparison with the control product.
2: Saltiness, taste, and the flavor of soy sauce were slightly enhanced in comparison with the control product.
1: Saltiness, taste, and the flavor of soy sauce were not enhanced in comparison with the control product.

### [Evaluation Criteria](Japanese Stock Soup)

4: Saltiness, taste, and the flavor of bonito were considerably enhanced in comparison with the control product.
3: Saltiness, taste, and the flavor of bonito were enhanced in comparison with the control product.
2: Saltiness, taste, and the flavor of bonito were slightly enhanced in comparison with the control product.
1: Saltiness, taste, and the flavor of bonito were not enhanced in comparison with the control product.

### [Evaluation Criteria](Consomme Soup)

4: Saltiness, taste, and the flavor of vegetable were considerably enhanced in comparison with the control product.
3: Saltiness, taste, and the flavor of vegetable were enhanced in comparison with the control product.
2: Saltiness, taste, and the flavor of vegetable were slightly enhanced in comparison with the control product.
1: Saltiness, taste, and the flavor of vegetable were not enhanced in comparison with the control product.
   [Evaluation Criteria](Chinese soup)
4: Saltiness, taste, and the flavor of chicken stock were considerably enhanced in comparison with the control product.
3: Saltiness, taste, and the flavor of chicken stock were enhanced in comparison with the control product.
2: Saltiness, taste, and the flavor of chicken stock were slightly enhanced in comparison with the control product.
1: Saltiness, taste, and the flavor of chicken stock were not enhanced in comparison with the control product.

TABLE 1

| | | | | | | | | | | Co. | Co. |
|---|---|---|---|---|---|---|---|---|---|---|---|
| | Ex. 1 | Ex. 2 | Ex. 3 | Ex. 4 | Ex. 5 | Ex. 6 | Ex. 7 | Ex. 8 | Ex. 9 | Ex. 1 | Ex. 2 |
| Heating temperature | 90 | 105 | 120 | 80 | 50 | 90 | 90 | 90 | 90 | 90 | 25 |
| (° C.) | | | | | | | | | | | |
| Extraction time (min) | 10 | 10 | 10 | 10 | 10 | 5 | 30 | 60 | 10 | 10 | 15 |
| pH of liquid containing | 5.0 | 5.0 | 5.0 | 5.0 | 5.0 | 5.0 | 5.0 | 5.0 | 5.0 | 5.0 | 5.0 |
| acetic acid bacterium | | | | | | | | | | | |
| Amount (parts by mass) | 15 | 15 | 15 | 15 | 15 | 15 | 15 | 15 | 30 | — | 15 |
| of bacterial cells of | | | | | | | | | | | |
| acetic acid bacterium | | | | | | | | | | | |
| with respect to 100 parts | | | | | | | | | | | |
| by mass of edible | | | | | | | | | | | |
| vegetable oil and fat | | | | | | | | | | | |
| Presence or absence of | Absent | Absent | Absent | Absent | Absent | Absent | Absent | Absent | Absent | Present | Absent |
| bacterial cells of acetic | | | | | | | | | | | |
| acid bacterium in oil and | | | | | | | | | | | |
| fat composition | | | | | | | | | | | |
| Sensory evaluation 1 | 4 | 4 | 4 | 2 | 2 | 4 | 4 | 4 | 4 | 1 | 1 |
| (flavor) | | | | | | | | | | | |

TABLE 2

| | Kind of food | | | | | | | |
|---|---|---|---|---|---|---|---|---|
| | | | | | | Japanese | | Chinese |
| | | Egg | Custard | Carbonara | Soy | stock | Consomme | stock |
| | Mayonnaise | spread | cream | sauce | sauce | soup | soup | soup |
| Amount (part(s) by | 2 | 1 | 1 | 1 | 1 | 1 | 1 | 1 |
| mass) of added oil and | | | | | | | | |
| fat composition with | | | | | | | | |
| respect to 100 parts by | | | | | | | | |
| mass of food | | | | | | | | |
| Sensory evaluation 2 | 4 | 4 | 4 | 4 | 4 | 4 | 4 | 4 |
| (flavor) | | | | | | | | |

### Production Example 2 of Oil and Fat Composition

### Examples 10 to 12

An aqueous sodium hydroxide solution or hydrochloric acid was added to the liquid containing the acetic acid bacterium in <Preparation of Liquid Containing Acetic Acid Bacterium> as described above, and the pH of the liquid containing the acetic acid bacterium was adjusted to each value set forth in Table 3. An oil and fat composition that included an edible vegetable oil and fat extract of an acetic acid bacterium and insoluble matter that was not passed through a mesh of 1 μm and was derived from the bacterial cells of the acetic acid bacterium, the insoluble matter being 0% by mass, was obtained in a manner similar to that in Example 1 except that the obtained liquid containing the acetic acid bacterium was used.

Subsequently, sensory evaluation was performed in a manner similar to that in <Sensory Evaluation 1 (Flavor)> except that the obtained oil and fat composition was used. The results of the sensory evaluation are as set forth in Table 3.

TABLE 3

| | Ex. 10 | Ex. 11 | Ex. 12 |
|---|---|---|---|
| Heating temperature (° C.) | 90 | 90 | 90 |
| Extraction time (min) | 10 | 10 | 10 |
| pH of liquid containing acetic acid | 7.0 | 3.0 | 2.0 |
| bacterium | | | |
| Amount (parts by mass) of bacterial | 15 | 15 | 15 |
| cells of acetic acid bacterium with | | | |
| respect to 100 parts by mass of | | | |
| edible vegetable oil and fat | | | |
| Presence or absence of bacterial cells | Absent | Absent | Absent |
| of acetic acid bacterium in oil and fat | | | |
| composition | | | |
| Sensory evaluation 1 (flavor) | 3 | 3 | 2 |

### Production Example 3 of Oil and Fat Composition

### Examples 13 and 14

An oil and fat composition that included an edible vegetable oil and fat extract of an acetic acid bacterium and insoluble matter that was not passed through a mesh of 1 μm and was derived from the bacterial cells of the acetic acid bacterium, the insoluble matter being 0% by mass, was obtained in a manner similar to that in Example 1 except that the kind of an edible vegetable oil and fat was changed to an edible vegetable oil and fat set forth in Table 4, in <Preparation of Oil And Fat Composition> as described above.

Subsequently, sensory evaluation was performed in a manner similar to that in <Sensory Evaluation 1 (Flavor)> except that the obtained oil and fat composition was used. The results of the sensory evaluation are as set forth in Table 4.

TABLE 4

| | Ex. 13 | Ex. 14 |
|---|---|---|
| Edible vegetable oil and fat | Soybean oil | White |
| | | sesame oil |
| Heating temperature (° C.) | 90 | 90 |
| Extraction time (min) | 10 | 10 |
| pH of liquid containing acetic acid | 5.0 | 5.0 |
| bacterium | | |
| Amount (parts by mass) of bacterial | 15 | 15 |
| cells of acetic acid bacterium with | | |
| respect to 100 parts by mass of | | |
| edible vegetable oil and fat | | |
| Presence or absence of bacterial cells | Absent | Absent |
| of acetic acid bacterium in oil and fat | | |
| composition | | |
| Sensory evaluation 1 (flavor) | 4 | 4 |

### Production Example 4 of Oil and Fat Composition

### Example 15

An oil and fat composition that included an edible vegetable oil and fat extract of an acetic acid bacterium and insoluble matter that was not passed through a mesh of 1 μm and was derived from the bacterial cells of the acetic acid bacterium, the insoluble matter being 0% by mass, was obtained in a manner similar to that in Example 1 except that dry matter of the bacterial cells of an acetic acid bacterium, obtained by spray-drying the liquid containing the acetic acid bacterium, was used instead of the liquid containing the acetic acid bacterium, in <Preparation of Oil And Fat Composition> as described above. The oil and fat composition was produced so that the amount of the dry matter of the bacterial cells of the acetic acid bacterium with respect to 100 parts by mass of an edible vegetable oil and fat was 15 parts by mass.

Subsequently, sensory evaluation was performed in a manner similar to that in <Sensory Evaluation 1 (Flavor)> except that the obtained oil and fat composition was used. As a result, the flavor of sesame was considerably enhanced in comparison with the control product.

### Production Example 5 of Oil and Fat Composition

### Example 16

The liquid containing the acetic acid bacterium (amount of dry matter of bacterial cells of acetic acid bacterium: 5% by mass) per se, prepared in <Preparation of Liquid Containing Acetic Acid Bacterium> as described above, was heated, and 300 parts by mass of the liquid containing the acetic acid bacterium (amount of dry matter of bacterial cells of acetic acid bacterium: 15 parts by mass) and 100 parts by mass of an edible vegetable oil and fat (rape oil) were then mixed, and extracted for 10 minutes. Then, the mixture was separated into an oil phase and an aqueous phase by centrifugation, the oil phase was collected, and an oil and fat composition that included an edible vegetable oil and fat extract of the acetic acid bacterium and insoluble matter that was not passed through a mesh of 1 μm and was derived from the bacterial cells of the acetic acid bacterium, the insoluble matter being 0% by mass, was obtained.

Subsequently, sensory evaluation was performed in a manner similar to that in <Sensory Evaluation 1 (Flavor)> except that the obtained oil and fat composition was used. As a result, the flavor of sesame was considerably enhanced in comparison with the control product.

1. An oil and fat composition comprising:
an edible vegetable oil and fat extract of an acetic acid bacterium; and
insoluble matter that is not passed through a mesh of 1 μm and is derived from a bacterial cell of an acetic acid bacterium, the insoluble matter being 1% by mass or less.

2. The oil and fat composition according to claim 1,
wherein the acetic acid bacterium is an acetic acid bacterium of at least one selected from a group consisting of genera Gluconacetobacter, Acetobacter, and Komagataeibacter.

3. The oil and fat composition according to claim 1,
wherein the oil and fat composition further comprises an edible vegetable oil and fat.

4. The oil and fat composition according to claim 1,
wherein the oil and fat composition is for use in food.

5. A food flavor enhancer comprising
the oil and fat composition according to claim 1.

6. A food comprising
the oil and fat composition or food flavor enhancer according to claim 1.

7. A method of producing an oil and fat composition comprising an edible vegetable oil and fat extract of an acetic acid bacterium, the method comprising:
a step of heating a liquid containing an acetic acid bacterium; and
a step of mixing the heated liquid containing the acetic acid bacterium with an edible vegetable oil and fat to extract an oil-soluble component derived from a bacterial cell of the acetic acid bacterium in the edible vegetable oil and fat.

8. A method of producing an oil and fat composition comprising an edible vegetable oil and fat extract of an acetic acid bacterium, the method comprising:
a step of mixing a liquid containing an acetic acid bacterium or dry matter of a bacterial cell of an acetic acid bacterium with an edible vegetable oil and fat to obtain a liquid mixture; and
a step of heating the liquid mixture to extract an oil-soluble component derived from the bacterial cell of the acetic acid bacterium in the edible vegetable oil and fat.

9. The method of producing an oil and fat composition according to claim 7,
wherein heating temperature is 40° C. or more and 130° C. or less.

10. The method of producing an oil and fat composition according to claim 7,
wherein a pH of the liquid containing the acetic acid bacterium is 2.0 or more and 7.0 or less.

11. The method of producing an oil and fat composition according to claim 8,
wherein an amount of the dry matter of the bacterial cell of the acetic acid bacterium is 1 part by mass or more and 100 parts by mass or less with respect to 100 parts by mass of the edible vegetable oil and fat.

12. The oil and fat composition according to claim 1,
wherein the content of the insoluble matter that is not passed through a mesh of 1 μm and is derived from a bacterial cell of an acetic acid bacterium is 0.5% by mass or less with respect to the total amount of the oil and fat composition.

13. The oil and fat composition according to claim 1,
wherein the content of the insoluble matter that is not passed through a mesh of 1 μm and is derived from a bacterial cell of an acetic acid bacterium is 0.1% by mass or less with respect to the total amount of the oil and fat composition.

14. The oil and fat composition according to claim 3,
wherein the edible vegetable oil and fat has a relative permittivity value of 4.0 or less.

15. The oil and fat composition according to claim 3,
wherein the edible vegetable oil and fat has a relative permittivity value of 3.8 or less.

16. The oil and fat composition according to claim 3,
wherein the edible vegetable oil and fat has a relative permittivity value of 3.5 or less.

17. The oil and fat composition according to claim 14,
wherein the edible vegetable oil and fat has a relative permittivity value of 2.5 or more.

18. The oil and fat composition according to claim 15,
wherein the edible vegetable oil and fat has a relative permittivity value of 2.7 or more.

19. The oil and fat composition according to claim 16,
wherein the edible vegetable oil and fat has a relative permittivity value of 2.9 or more.
